(19) United States
(12) Patent Application Publication
(10) Pub. No.: US 2021/0027212 A1
(43) Pub. Date: Jan. 28, 2021

(54) OFFLINE TO ONLINE VEHICLE BOOKING

(71) Applicant: OLA ELECTRIC MOBILITY PRIVATE LIMITED, Bengaluru (IN)

(72) Inventors: Achal Gupta, Ghaziabad (IN); Sathya Narayanan Nagarajan, Bengaluru (IN); Dinesh Dharmaraj, Sirumugai (IN); Himanshu Retarekar, Bangalore (IN); Riyaz Mohammed Ibrahim A, Bangalore (IN); Shreeyash Salunke, Pune (IN); Ravi Shankar Singh Ahirwar, Bhopal (IN); Arjun S, Bangalore (IN); Krishna Prasad Kuruva, Kurnool (IN); Poorva Mankad, Bangalore (IN); Sudhir Singh Mor, Ahmedabad (IN); Parth Suthar, Bangalore (IN); Santosh Vaidyanathan, Bangalore (IN); Suresh Shanmugasundaram, Tirupur (IN)

(73) Assignee: OLA ELECTRIC MOBILITY PRIVATE LIMITED, Bengaluru (IN)

(21) Appl. No.: 16/934,311

(22) Filed: Jul. 21, 2020

(30) Foreign Application Priority Data
Jul. 23, 2019 (IN) 201941029811

(51) Int. Cl. G06Q 10/02; G06Q 50/30; G06K 7/10; G06K 19/06

(52) U.S. Cl. CPC G06Q 10/02; G06K 19/06037; G06K 7/10237; G06Q 50/30

(57) ABSTRACT

An offline to online booking of a street-hailed vehicle by a passenger includes scanning a quick response (QR) code or a near-field communication (NFC) sticker associated with the street-hailed vehicle. Based on the scanning, QR or NFC information is retrieved from the QR code or the NFC sticker, respectively. The QR or NFC information is further processed to determine an availability of the street-hailed vehicle for allocation to the passenger. The street-hailed vehicle is further allocated to the passenger based on successful conversion of the offline to online booking of the street-hailed vehicle. A driver of the street-hailed vehicle transports the passenger from a current location to a destination location based on the allocation.

### CROSS-RELATED APPLICATIONS

This application claims priority of Indian Non-Provisional Application No. 201941029811, filed Jul. 23, 2019, the contents of which are incorporated herein by reference.

### FIELD

Various embodiments of the disclosure relate generally to vehicle allocation systems. More specifically, various embodiments of the disclosure relate to offline to online vehicle booking.

### BACKGROUND

Traveling has become an important part of everyone's life. With the advent of the Internet, online booking for on-demand vehicle services has increased enormously. Conventionally, a traveler initiates a booking request for a ride in an online manner by means of a ride-haling application that communicates with a ride-haling server utilized by a cab service provider. The ride-haling server receives the booking request and allocates an available vehicle to the traveler for the ride. Upon allocation, the traveler waits for the allocated vehicle at the traveler's pick-up location and boards the allocated vehicle for the ride when the allocated vehicle reaches the pick-up location. In other way round, a driver of the allocated vehicle reaches the traveler's pick-up location and waits for the traveler. In both the cases, upon allocation of the vehicle, the traveler or the driver has to wait for the ride to start that may not be desirable for any one of them.

Furthermore, even though the online booking of the on-demand vehicle services is on the rise, a majority of the potential travelers are still aligned to street-hailed vehicles for commuting between a plurality of locations in an offline manner. Such an offline way of availing ride-hailing services has its own benefits such as a quick access to an available vehicle for a ride, a low waiting time, no dry run for a driver of the vehicle, or the like. However, in such an offline way of riding in a street-hailed vehicle, the traveler is not digitally connected to the street-hailed vehicle. Also, the traveler is not digitally connected to a driver of the street-hailed vehicle or to any other ride sharing platform. As a result, in today's world, the traveler cannot avail various online services or features associated with safety, convenience, entertainment, and productivity offered by the vehicle, the driver, or the ride sharing platform.

In light of the foregoing, there exists a need for a technical and more reliable solution that overcomes the above-mentioned problems, challenges, and short-comings, and manages ride-haling services in a manner that may offer best experiences to travelers from the two worlds i.e., traditional and digital.

### SUMMARY

An offline to online vehicle booking is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an environment for offline to online vehicle booking, in accordance with an exemplary embodiment of the disclosure;

FIG. 2 is a block diagram that illustrates a transportation server of the environment of FIG. 1, in accordance with an exemplary embodiment of the disclosure;

FIG. 3A is a block diagram that illustrates a booking user interface rendered on a passenger device of the environment of FIG. 1, in accordance with an exemplary embodiment of the disclosure;

FIG. 3B is a block diagram that illustrates a scanning user interface rendered on the passenger device, in accordance with an exemplary embodiment of the disclosure;

FIG. 3C is a block diagram that illustrates a destination user interface rendered on the passenger device, in accordance with an exemplary embodiment of the disclosure;

FIG. 3D is a block diagram that illustrates an in-vehicle feature user interface rendered on the passenger device, in accordance with an exemplary embodiment of the disclosure;

FIG. 3E is a block diagram that illustrates a tracking user interface rendered on the passenger device, in accordance with an exemplary embodiment of the disclosure;

FIG. 3F is a block diagram that illustrates a payment user interface rendered on the passenger device, in accordance with an exemplary embodiment of the disclosure;

FIG. 4 is a flow chart that illustrates a method for availing an offline to online booking of a street-hailed vehicle by a passenger of the environment of FIG. 1, in accordance with an exemplary embodiment of the disclosure;

FIG. 5 is a flow chart that illustrates a method for processing an offline to online booking of the street-hailed vehicle, in accordance with an exemplary embodiment of the disclosure; and

FIG. 6 is a block diagram that illustrates a computer system for facilitating an offline to online booking of the street-hailed vehicle, in accordance with an exemplary embodiment of the disclosure.

### DETAILED DESCRIPTION

Certain embodiments of the disclosure may be found in a disclosed apparatus for vehicle booking. Exemplary aspects of the disclosure provide a method and a system for offline to online booking of a street-hailed vehicle by a passenger by utilizing a passenger device. The passenger device may be communicatively coupled with at least one of a driver device of a driver of the street-hailed vehicle or a transportation server of a ride-hailing service provider via communication network. The method includes one or more operations that are executed by the passenger device to perform the offline to online booking of the street-hailed vehicle. The passenger device may be configured to scan a quick response (QR) code or a near-field communication (NFC) sticker associated with the street-hailed vehicle. The passenger device may scan the QR code or the NFC sticker based on an input provided by the passenger by means of a service application that runs on the passenger device. In an embodiment, the passenger device may be configured to scan the QR code or the NFC sticker to retrieve QR or NFC information associated with the QR code or the NFC sticker, respectively. The QR or NFC information may include at least one of driver or vehicle information associated with the street-hailed vehicle. The passenger device may be further configured to transmit the QR or NFC information to the transportation server via the communication network. The QR or NFC information may be transmitted for initiating the offline to online booking of the street-hailed vehicle. When the street-hailed vehicle is available for the ride, the passenger device may be further configured to receive allocation information from the transportation server via the communication network. The allocation information may indicate successful conversion of the offline to online booking of the street-hailed vehicle that is allocated to the passenger. Thereafter, based on the allocation of the street-hailed vehicle to the passenger, the driver of the street-hailed vehicle may transport the passenger from a current location to a destination location of the passenger.

Another exemplary aspect of the disclosure provides a method and a system for offline to online booking of a street-hailed vehicle requested by a passenger. The method includes one or more operations that are executed by a transportation server to process the offline to online booking of the street-hailed vehicle. The transportation server may be configured to receive, from a passenger device of the passenger via a communication network, quick response (QR) or near-field communication (NFC) information corresponding to a QR code or an NFC sticker associated with the street-hailed vehicle. The QR or NFC information may be received when the passenger device scans the QR code or the NFC sticker based on the offline to online booking of the street-hailed vehicle initiated by the passenger. The QR or NFC information may include at least one of driver or vehicle information associated with the street-hailed vehicle. The transportation server may be further configured to process the QR or NFC information to determine an availability of the street-hailed vehicle for allocation to the passenger. The transportation server may be further configured to allocate the street-hailed vehicle to the passenger based on successful conversion of the offline to online booking of the street-hailed vehicle. The offline to online booking may be successfully converted when the street-hailed vehicle is available for the allocation. The transportation server may be further configured to transmit allocation information to at least one of the passenger device or a driver device of a driver of the street-hailed vehicle via the communication network. The allocation information may indicate the offline to online booking of the street-hailed vehicle that is allocated to the passenger. Based on the allocation of the street-hailed vehicle to the passenger, the driver may drive the street-hailed vehicle to transport the passenger from a current location to a destination location of the passenger.

Various booking methods and systems of the disclosure facilitate offline to online booking of a street-hailed vehicle. The street-hailed vehicle may be hailed by a passenger for a ride in an offline manner. Further, to avail one or more in-vehicle services or features in an online manner, the offline to online booking of the street-hailed vehicle may be initiated by the passenger. With such offline to online booking of the street-hailed vehicle, the passenger or a driver of the street-hailed vehicle may not have to wait for the driver or the passenger, respectively. Furthermore, a dry run for the driver is minimized that may result in higher earnings for the driver. Also, when the street-hailed vehicle is converted into an online ride by the passenger, the passenger may keep track of the ongoing ride in an online manner and may share a live feed of the ongoing ride to preferred contacts, such as family, friends, or the like, who are associated with the passenger. Thus, the passenger may enjoy enhanced safety and security services even when the passenger is riding with the street-hailed vehicle. Furthermore, with such offline to online booking of the street-hailed vehicle, the passenger may use an online payment mode for making payments for the ride with the street-hailed vehicle. Similarly, the driver may accept the payments for the ride from the passenger in an online manner that is hassle free. Various other advantages and improvements of the disclosure will become apparent from the detailed description provided hereinafter.

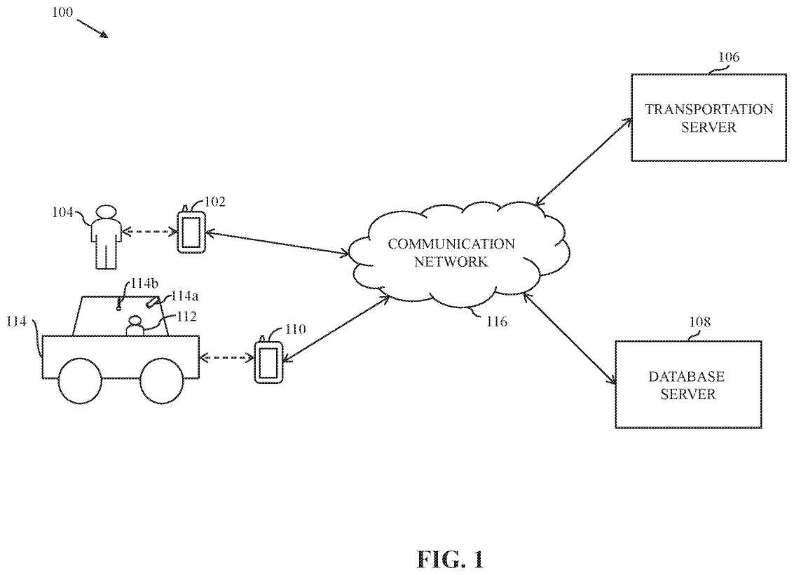

FIG. 1 is a block diagram that illustrates an environment 100 for offline to online vehicle booking, in accordance with an exemplary embodiment of the disclosure. The environment 100 includes a passenger device 102 of a passenger 104, a transportation server 106, a database server 108, a driver device 110 of a driver 112 of a vehicle 114, and a communication network 116. In one example, the vehicle 114 may be stopped by the passenger 104 along a street for a ride in an offline manner. In another example, the driver 112 of the vehicle 114 may be waiting at a stopover along the street for potential riders and the passenger 104 may hail or board the vehicle 114 for the ride in the offline manner. Thus, the vehicle 114 may be designated and referred to as the street-hailed vehicle 114. Further, the street-hailed vehicle 114 may include one or more in-vehicle image-capturing and audio-capturing devices such as an image-capturing device 114a and an audio-capturing device 114b. In an embodiment, the passenger device 102, the transportation server 106, the database server 108, and the driver device 110 are connected to each other by means of the communication network 116.

The passenger device 102 may include suitable logic, circuitry, interfaces, and/or code, executable by the circuitry, that may be configured to perform one or more operations for offline to online vehicle booking. The passenger device 102 may be a computing device that is utilized, by the passenger 104, to initiate the one or more operations by means of a service application (associated with a vehicle service provider such as OLA) running on the passenger device 102. For example, the passenger device 102 may be utilized, by the passenger 104, to initiate a booking request for a ride using the street-hailed vehicle 114. In an embodiment, the booking request may be initiated, by the passenger 104, to request the ride by scanning a quick response (QR) code or a near-field communication (NFC) sticker associated with the street-hailed vehicle 114 by means of the service application. The QR code or the NFC sticker is a machine-readable optical label that may include information associated with the driver 112, the street-hailed vehicle 114, or a combination thereof. For example, the information may include driver information (such as a driver's name, a driver's registered contact identifiers, a driver's driving license, or the like) of the driver 112, vehicle information (such as a vehicle type, a vehicle registration make, a vehicle number, or the like) of the street-hailed vehicle 114, or a combination thereof.

In another embodiment, the booking request may be initiated, by the passenger 104, to request the ride by entering a vehicle number of the street-hailed vehicle 114 by means of the service application. The vehicle number (commonly referred as a vehicle identification number “VIN”) is a unique code including a serial number that is utilized by an entity (such as an automotive industry) to identify vehicles such as the street-hailed vehicle 114. In yet another embodiment, the booking request may be initiated, by the passenger 104, to request the ride by scanning the QR code or the NFC sticker, followed by entering the vehicle number, or vice-versa.

In one exemplary embodiment, based on the booking requested initiated by the passenger 104, the passenger device 102 may be configured to scan the QR code or the NFC sticker associated with the street-hailed vehicle 114 and retrieve QR or NFC information from the QR code or the NFC sticker, respectively. Upon scanning the QR code or the NFC sticker, the passenger device 102 may be further configured to transmit the QR or NFC information to the transportation server 106 via the communication network 116. The passenger device 102 may transmit the QR or NFC information for initiating the offline to online booking of the street-hailed vehicle 114. The passenger device 102 may be further configured to receive allocation information from the transportation server 106 via the communication network 116. The allocation information may be received based on successful conversion of the offline to online booking of the street-hailed vehicle 114 by the transportation server 106 when the street-hailed vehicle 114 is available for allocation (i.e., the ride requested by the passenger 104). The allocation information may indicate at least allocation of the street-hailed vehicle 114 to the passenger 104 for the ride. The passenger device 102 may be further utilized, by the passenger 104, to view the allocation information including the driver information of the driver 112, the vehicle information of the street-hailed vehicle 114, or a combination thereof. Based on the allocation information, the passenger 104 may request the driver 112 to start the ride.

In accordance with an embodiment, the passenger device 102 may be utilized, by the passenger 104, to input a destination location for the ride by means of the service application. The passenger device 102 may be further utilized, by the passenger 104, to initiate one or more requests (hereinafter, “the requests”) by means of the service application. The requests may be initiated to control, modify, or execute one or more in-vehicle services or features (hereinafter, “the in-vehicle features”) associated with the street-hailed vehicle 114 during the ride. The in-vehicle features may be offered to the passenger 104 by the transportation server 106 in an online manner after the start of the ride. The in-vehicle features may be associated with heating, ventilation, and air conditioning (HVAC) of the street-hailed vehicle 114. The in-vehicle features may be further associated with various in-vehicle infotainment or safety services that may be availed by the passenger 104 during the ride. The in-vehicle features may be further associated with activation or deactivation of various in-vehicle devices such as the image-capturing device 114a or the audio-capturing device 114b.

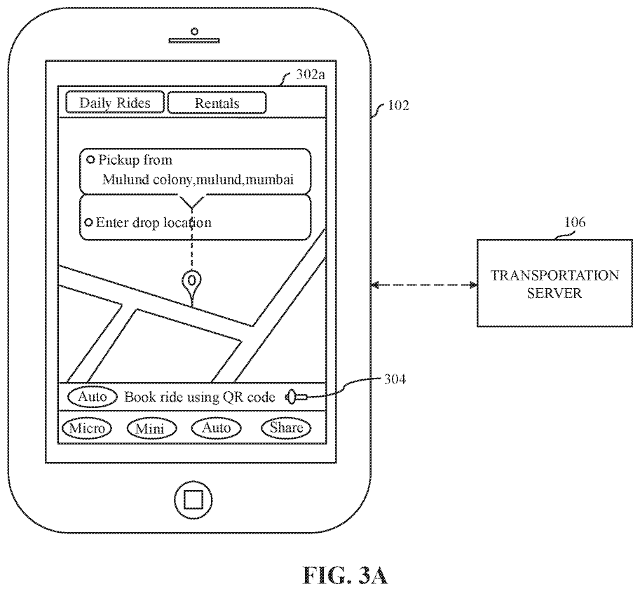

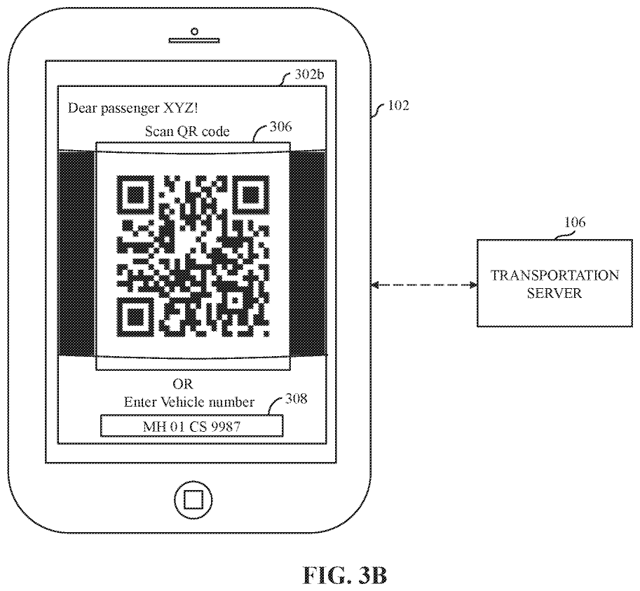

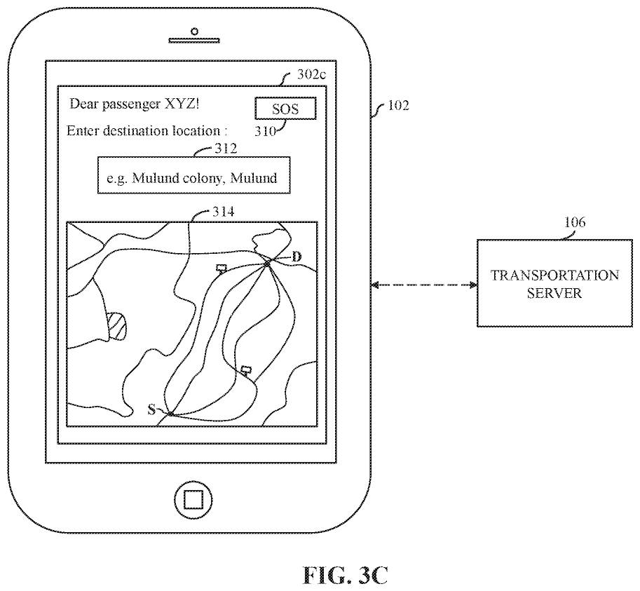

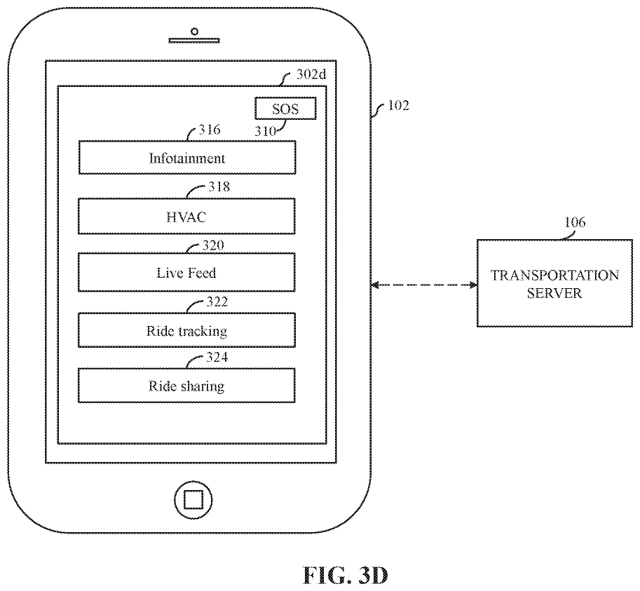

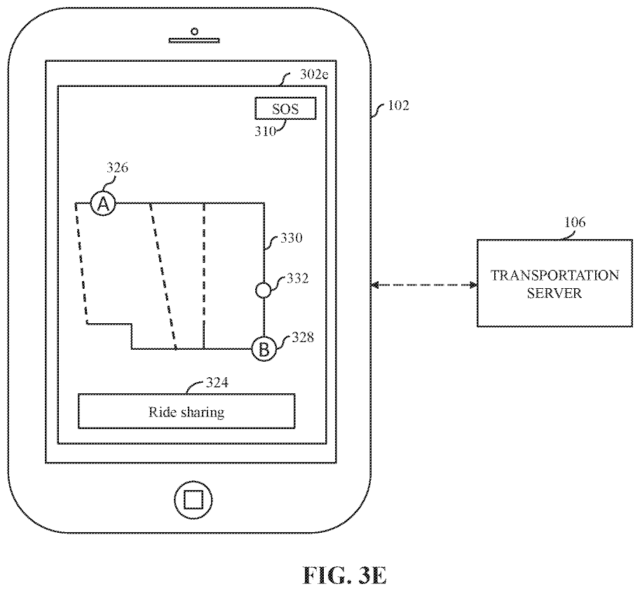

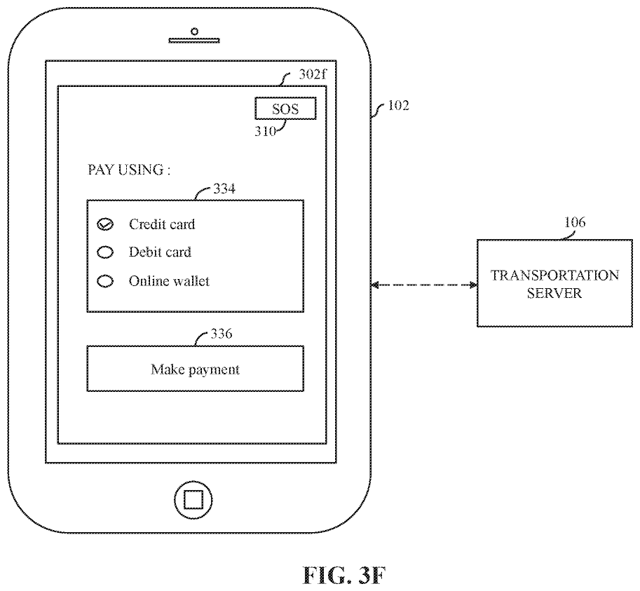

In accordance with an embodiment, the passenger device 102 may be utilized, by the passenger 104, to track real-time ride information associated with the ongoing ride. The real-time ride information may include at least one of position information, route information, direction information, fare information, or ride distance and time information. The passenger device 102 may be further utilized, by the passenger 104, to share the real-time ride information with one or more preferred contacts by means of the service application. The passenger device 102 may be further utilized, by the passenger 104, to initiate an access request for accessing or retrieving one or more emergency identifiers from the transportation server 106 or the database server 108 in an event of an emergency incident. The passenger device 102 may be further utilized, by the passenger 104, to share a live feed of in-vehicle activities with the one or more preferred contacts by means of the service application. The passenger device 102 may be further utilized, by the passenger 104, to initiate an electronic transaction request to make an online payment corresponding to a ride fare associated with the ride. The passenger device 102 may be configured to transmit the electronic transaction request to the transportation server 106 based on an online payment mode selected by the passenger 104. Various operations of the passenger device 102 have been described in detail in conjunction with FIGS. 3A-3F. Examples of the passenger device 102 include, but are not limited to, a personal computer, a laptop, a smartphone, and a tablet computer.

The transportation server 106 may include suitable logic, circuitry, interfaces, and/or code, executable by the circuitry, that may be configured to perform one or more operations for the offline to online vehicle booking. The transportation server 106 may be a computing device, which may include a software framework, that may be configured to create the transportation server implementation and perform the various operations associated with the offline to online vehicle booking. The transportation server 106 may be realized through various web-based technologies, such as, but not limited to, a Java web-framework, a .NET framework, a PHP framework, a python framework, or any other web-application framework. Examples of the transportation server 106 include, but are not limited to, a personal computer, a laptop, or a network of computer systems.

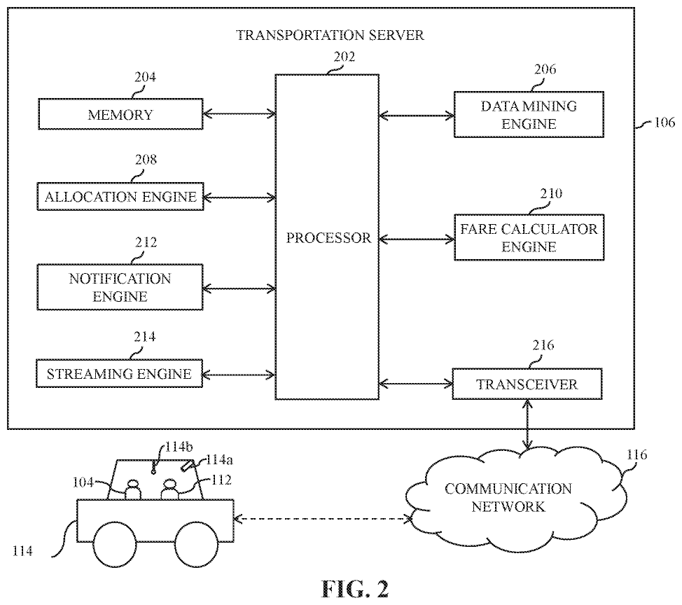

In an embodiment, the transportation server 106 may be configured to receive the QR or NFC information from the passenger device 102 via the communication network 116. The transportation server 106 may be further configured to process the QR or NFC information to determine an availability of the street-hailed vehicle 114 for the ride requested by the passenger 104. The availability of the street-hailed vehicle 114 may be determined based on real-time allocation information of the street-hailed vehicle 114. The real-time allocation information may be retrieved from the database server 108 (or from a memory shown in FIG. 2) based on the QR or NFC information. For example, the transportation server 106 may process the QR or NFC information to determine the driver and vehicle information of the driver 112 and the street-hailed vehicle 114, respectively. In another example, the transportation server 106 may communicate the QR or NFC information as a query to the database server 108 for retrieving the driver and vehicle information. Based on at least one of the driver and vehicle information, the transportation server 106 may obtain the real-time allocation information of the street-hailed vehicle 114 and determine the availability of the street-hailed vehicle 114 (i.e., whether the street-hailed vehicle 114 is available for allocation or not for the ride requested by the passenger 104). Thereafter, when the street-hailed vehicle 114 is available for the ride, the transportation server 106 may allocate the street-hailed vehicle 114 to the passenger 104 for the ride. Based on the allocation, the transportation server 106 may be further configured to generate and transmit the allocation information to the passenger device 102 and/or the driver device 110. The allocation information may indicate allocation of the street-hailed vehicle 114 to the passenger 104 for the ride. The allocation information may also include at least one of the driver information, the vehicle information, passenger information, or the like. Based on the allocation information, the street-hailed vehicle 114 may be driven by the driver 112 to transport the passenger 104 from a current location to the destination location associated with the ride. The destination location for the ride may be specified by the passenger 104 in an offline manner (e.g., verbally), an online manner (e.g., the service application), or a combination thereof. For example, the passenger 104 may verbally communicate the destination location to the driver 112. In another example, the passenger device 102 may be utilized, by the passenger 104, to specify the destination location by means of the service application. In one exemplary scenario, the destination location for the ride may be specified by the passenger 104 at the time of the scanning process itself. In another exemplary scenario, the destination location may be specified by the passenger 104 after allocation of the street-hailed vehicle 114 to the passenger 104 for the ride.

In an embodiment, the transportation server 106 may be configured to receive the destination location from the passenger device 102 and store the received destination location in a memory (shown in FIG. 2). Upon receiving the destination location from the passenger device 102, the transportation server 106 may be configured to communicate the destination location of the ride to the driver 112. For example, the transportation server 106 may render a digital map on the driver device 110 for facilitating navigational direction from the current location to the destination location. The driver 112 may use the rendered digital map to navigate from the current location to the destination location of the passenger 104.

In an embodiment, the transportation server 106 may be configured to render one or more user interfaces (hereinafter, “the user interfaces”) on the passenger device 102 based on the requests initiated by the passenger 104. For example, the transportation server 106 may render a tracking user interface (shown in FIG. 3E) on the passenger device 102 by means of the service application, based on a tracking request initiated by the passenger 104. The tracking user interface may present the real-time ride information including at least one of the position information, the route information, the direction information, the fare information, or the ride distance and time information associated with the ongoing ride. The real-time ride information may be presented in the form of a graphical representation, a textual representation, a video representation, an audio representation, or any combination thereof. The tracking user interface may also include one or more selectable options (such as one or more tabs) that may be selected by the passenger 104 to share the real-time ride information with the one or more preferred contacts. The real-time ride information may be shared with the one or more preferred contacts by means of the service application.

In an embodiment, the transportation server 106 may be configured to activate or deactivate at least one of the image-capturing device 114a and the audio-capturing device 114b associated with the street-hailed vehicle 114 based on an activation or deactivation request, which may be initiated by the passenger 104 during the ride. The image-capturing device 114a and the audio-capturing device 114b may be activated to capture and record real-time in-vehicle activities associated with the street-hailed vehicle 114. Further, the image-capturing device 114a and the audio-capturing device 114b may be deactivated to stop capturing and recording of the real-time in-vehicle activities. Although the transportation server 106 may be configured to control activation or deactivation of the image-capturing device 114a and the audio-capturing device 114b based on the activation or deactivation request triggered by the passenger 104, the image-capturing device 114a and the audio-capturing device 114b may directly receive these triggered signals (i.e., the activation or deactivation request) from the passenger device 102. Thereafter, based on the received triggered signals, the image-capturing device 114a and the audio-capturing device 114b may be automatically activated or deactivated without requiring any instruction from the transportation server 106. In another embodiment, the passenger device 102 may be configured to directly communicate the triggered signals to a central vehicle-computing device (not shown) installed in the street-hailed vehicle 114 via the communication network 116. In such a scenario, the central vehicle-computing device may control activation or deactivation of the image-capturing device 114a and the audio-capturing device 114b based on the received triggered signals. Though the central vehicle-computing device has not been explicitly shown in FIG. 1, in some embodiments, the driver device 110 may be configured to operate as the central vehicle-computing device without limiting the scope of the disclosure.

In an embodiment, the transportation server 106 may be configured to communicate the live feed of the in-vehicle activities to the one or more preferred contacts of the passenger 104 based on a sharing request initiated by the passenger 104 during the ride. The transportation server 106 may be further configured to receive the electronic transaction request from the passenger device 102. The transportation server 106 may process the electronic transaction request to debit an electronic or digital money from a passenger's account (such as an online bank account, a debit card account, a credit card account, a wallet account, or the like) of the passenger 104. The electronic or digital money debited from the passenger's account may be equivalent to the ride fare. The transportation server 106 may be further configured to process other feature-related requests initiated by the passenger 104 during the ride, and accordingly, may control, modify, and execute the in-vehicle features associated with the HVAC and in-vehicle infotainment services. Various operations of the transportation server 106 have been described in detail in conjunction with FIGS. 2-6.

The database server 108 may include suitable logic, circuitry, interfaces, and/or code, executable by the circuitry, that may be configured to perform one or more operations, such as receiving, storing, processing, and transmitting queries, data, or content. The database server 108 may be a data management and storage computing device that is communicatively coupled with the passenger device 102, the transportation server 106, and the driver device 110 via the communication network 116 to perform the one or more operations. In an exemplary embodiment, the database server 108 may be configured to manage and store the passenger information of each passenger (such as the passenger 104), the driver information of each driver (such as the driver 112), and the vehicle information of each vehicle (such as the street-hailed vehicle 114). For example, the passenger information of each passenger may include at least a passenger name, a passenger identifier (ID), and a passenger contact number, along with other information pertaining to a passenger account of each passenger registered with the vehicle service provider. Similarly, the driver information of each driver may include at least a driver name, a driver ID, and a registered vehicle make, along with other information pertaining to a driver account of each driver registered with the vehicle service provider. Similarly, the vehicle information of each vehicle may include at least a vehicle type, an associated QR code or NFC sticker, a vehicle number, a vehicle chassis number, or the like. In an embodiment, the circuitry of the database server 108 may be configured to generate a tabular data structure including one or more rows and columns and store the information of the passengers (and/or the drivers and the vehicles) in a structured manner. For example, each row may be associated with each passenger having a unique passenger ID, and one or more columns corresponding to each row may indicate the passenger information.

In an embodiment, the database server 108 may be configured to store the allocation information (i.e., information indicating the current availability status) of each vehicle (such as the street-hailed vehicle 114) associated with the vehicle service provider. The allocation information of each vehicle may be dynamically updated in real-time by the transportation server 106 based on the current allocation status of each vehicle. The current allocation status of each vehicle may indicate whether each vehicle is available for new allocation or not corresponding to new booking request.

In an embodiment, the database server 108 may be configured to receive one or more queries from the transportation server 106 via the communication network 116. The one or more queries may indicate one or more requests for retrieving requisite information (such as the vehicle information, the driver information, the passenger information, the real-time allocation information, or any combination thereof). For example, the database server 108 may receive the QR or NFC information (corresponding to the scanned QR code or the scanned NFC sticker, respectively) as a query for retrieving at least one of the driver, vehicle, and real-time allocation information associated with the street-hailed vehicle 114. In another example, the database server 108 may receive the vehicle information (e.g., the vehicle number) associated with the street-hailed vehicle 114 as a query for retrieving at least one of the driver, vehicle, and real-time allocation information. In yet another example, the database server 108 may receive the QR or NFC information along with the vehicle information (e.g., the vehicle number) as a query for retrieving at least one of the driver, vehicle, and real-time allocation information. In response to the received query, the database server 108 may be configured to retrieve and transmit the requested information to the transportation server 106 via the communication network 116. Examples of the database server 108 include, but are not limited to, a personal computer, a laptop, or a network of computer systems.

The driver device 110 may include suitable logic, circuitry, interfaces, and/or code, executable by the circuitry, that may be configured to perform one or more operations associated with various ride services. The driver device 110 may be a computing device that is utilized by the driver 112 of the street-hailed vehicle 114 to perform the one or more operations. For example, the driver device 110 may be utilized, by the driver 112, to input or update the driver or vehicle information by means of a service application that runs on the driver device 110. The driver device 110 may be further utilized, by the driver 112, to login or logout of a ride-hailing platform (e.g., the transportation server 106) associated with the vehicle service provider. The driver device 110 may be further utilized, by the driver 112, to input one or more preferences for working hours, ride types, feedback, or the like. The driver device 110 may be further utilized, by the driver 112, to navigate between a plurality of locations by means of the digital map facilitated by the transportation server 106. Further, the driver device 110 may be configured to transmit information, such as an availability status, a current booking status, a ride completion status, a ride fare, or the like, to the transportation server 106 or the database server 108 via the communication network 116. In one example, such information may be automatically detected by the service application running on the driver device 110. In another example, the driver 112 may manually update the information after a regular interval of time or after completion of each ride. In an exemplary embodiment, the driver device 110 may be a vehicle head unit. In another exemplary embodiment, the driver device 110 may be an external communication device, such as a smartphone, a tablet computer, a laptop, or any other portable communication device, that is placed inside the street-hailed vehicle 114.

The communication network 116 may include suitable logic, circuitry, interfaces, and/or code, executable by the circuitry, that may be configured to transmit queries, messages, and requests between various entities, such as the passenger device 102, the transportation server 106, the database server 108, and/or the driver device 110. Examples of the communication network 116 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the environment 100 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the passenger device 102 may be configured to scan the QR code or the NFC sticker associated with the street-hailed vehicle 114 based on the booking request initiated by the passenger 104. During the scanning process, the passenger device 102 may be configured to retrieve the QR or NFC information associated with the QR code or the NFC sticker, respectively. The passenger device 102 may be further configured to transmit the booking request including at least the QR or NFC information to the transportation server 106 via the communication network 116.

The transportation server 106 may be configured to receive the booking request from the passenger device 102 and process the booking request to obtain the QR or NFC information. The transportation server 106 may be further configured to process the QR or NFC information to determine at least one of the driver and vehicle information associated with the street-hailed vehicle 114. Based on at least one of the driver and vehicle information, the transportation server 106 may be further configured to determine the real-time allocation information of the street-hailed vehicle 114. In one example, to determine the real-time allocation information of the street-hailed vehicle 114, the transportation server 106 may generate the query based on at least one of the driver and vehicle information (or the QR or NFC information) and communicate the generated query to the database server 108 to retrieve the real-time allocation information of the street-hailed vehicle 114.

The transportation server 106 may be further configured to process the real-time allocation information of the street-hailed vehicle 114 to determine the availability of the street-hailed vehicle 114 for the requested ride. The availability of the street-hailed vehicle 114 indicates whether the street-hailed vehicle 114 is available or unavailable for allocation corresponding to the ride requested by the passenger 104. In a scenario in which the street-hailed vehicle 114 is available for the ride, the transportation server 106 may be configured to allocate the street-hailed vehicle 114 to the passenger 104 for the ride. Further, the transportation server 106 may be configured to generate the allocation information, including at least one of the driver information, the vehicle information, the passenger information, or the like, based on the allocation of the street-hailed vehicle 114 to the passenger 104 for the ride. The transportation server 106 may be further configured to transmit the allocation information to the passenger device 102 and/or the driver device 110. Based on the allocation information, the driver 112 may drive the street-hailed vehicle 114 to transport the passenger 104 from the current location to the destination location of the passenger 104. The destination location may be specified by the passenger 104 in the offline manner (e.g., using verbal communication with the driver 112), the online manner (e.g., using the service application running on the passenger device 102), or a combination thereof.

In a scenario in which the destination location for the ride may be specified by the passenger 104 in the online manner, the transportation server 106 may be configured to receive the destination location from the passenger device 102 via the communication network 116. In this regard, the transportation server 106 receives the destination location after allocating the street-hailed vehicle 114 to the passenger 104 for the ride. However, in certain scenarios, the transportation server 106 may receive the destination location along with the QR or NFC information included in the booking request without limiting the scope of the disclosure. Upon receiving the destination location from the passenger device 102, the transportation server 106 may communicate the destination location of the ride to the driver 112 of the street-hailed vehicle 114. The driver 112 may input the destination location on the digital map (hosted by the transportation server 106) for navigating from the current location to the destination location of the passenger 104. In another example, the transportation server 106 may locate the destination location on the digital map for facilitating navigation from the current location to the destination location of the passenger 104.

Upon allocation of the street-hailed vehicle 114 to the passenger 104, the passenger device 102 may be utilized, by the passenger 104, to initiate the requests for availing the in-vehicle services or features associated with the street-hailed vehicle 114 in the online manner. The various in-vehicle services or features may be associated with the HVAC, in-vehicle infotainment, safety services, online payments, live feed, live tracking, or the like. The transportation server 106 may receive the requests from the passenger device 102, process the received requests, and accordingly controls, modifies, and executes the in-vehicle services or features during or after the ride. Thus, various embodiments of the disclosure facilitate the offline to online booking of the street-hailed vehicle 114 by the passenger 104. With such offline to online booking of the street-hailed vehicle 114, the passenger 104 or the driver 112 may not have to wait for the driver 112 or the passenger 104, respectively, at a pick-up location after allocation of the street-hailed vehicle 114 to the passenger 104, which is quite common under current booking scenarios. Furthermore, the offline to online booking of the street-hailed vehicle 114 facilitates optimization of a dry run for the driver 112 that may result in higher earnings for the driver 112. Also, the passenger 104 may keep track of the ongoing ride in the online manner and may share the live feed of the ongoing ride to the one or more preferred contacts, such as family, friends, acquaintances, or the like. Thus, the passenger 104 may enjoy enhanced safety and security services even when the passenger 104 is riding with the street-hailed vehicle 114. The offline to online booking further facilitates the online payment mode that may be selected by the passenger 104 to initiate the electronic transaction request to make the online payment corresponding to the ride fare for the ride. The transportation server 106 may process the electronic transaction request to obtain the ride fare from the passenger 104 in an online manner that is more convenient to the passenger 104 as well as the driver 112. Various operations along with their advantages and improvements of the disclosure will become apparent in conjunction with FIGS. 2, 3A-3F, and 4-6.

FIG. 2 is a block diagram that illustrates the transportation server 106, in accordance with an exemplary embodiment of the disclosure. The transportation server 106 includes the circuitry such as a processor 202, a memory 204, a data mining engine 206, an allocation engine 208, a fare calculator engine 210, a notification engine 212, a streaming engine 214, and a transceiver 216 that communicate with each other by means of a communication bus (not shown).

The processor 202 may include suitable logic, circuitry, interfaces, and/or codes, executable by the circuitry, that may be configured to perform the one or more operations for the offline to online vehicle booking. For example, the processor 202 may be configured to receive the QR or NFC information corresponding to the QR code or the NFC sticker associated with the street-hailed vehicle 114 from the passenger device 102 by way of the transceiver 216 via the communication network 116, and stores the QR or NFC information in the memory 204. The processor 202 may be further configured to control and manage extraction of the requisite information from the database server 108 by means of the data mining engine 206, allocation of various vehicles (such as the street-hailed vehicle 114) to various passengers (such as the passenger 104) by means of the allocation engine 208, and computation of the ride fare for each ride (such as the ride requested by the passenger 104) by means of the fare calculator engine 210. The processor 202 may be further configured to control and manage rendering of the user interfaces on the passenger device 102 (and/or the driver device 110) by means of the notification engine 212. The processor 202 may be further configured to control and manage streaming of the in-vehicle activities to the one or more preferred contacts of the passenger 104 by means of the streaming engine 214. In an embodiment, the processor 202 may be configured to receive the requests corresponding to the in-vehicle features from the passenger device 102 by way of the transceiver 216 via the communication network 116, and stores the requests in the memory 204. The processor 202 may be further configured to process the requests to control, modify, manage, and execute various operations associated with the in-vehicle features requested by the passenger 104.

In an embodiment, the processor 202 may be configured to operate as a master processing unit, and the data mining engine 206, the allocation engine 208, the fare calculator engine 210, the notification engine 212, and the streaming engine 214 may be configured to operate as slave processing units. In such a scenario, the processor 202 may instruct the data mining engine 206, the allocation engine 208, the fare calculator engine 210, the notification engine 212, and the streaming engine 214 to perform their corresponding operations either independently or in conjunction with each other. Examples of the processor 202 include, but are not limited to, an application-specific integrated circuit (ASIC) processor, a reduced instruction set computing (RISC) processor, a complex instruction set computing (CISC) processor, and a field-programmable gate array (FPGA). It will be apparent to a person skilled in the art that the processor 202 may be compatible with multiple operating systems.

The memory 204 may include suitable logic, circuitry, interfaces, and/or codes, executable by the circuitry, that may be configured to store one or more instructions or codes that are executed by the processor 202, the data mining engine 206, the allocation engine 208, the fare calculator engine 210, the notification engine 212, and the streaming engine 214 to perform their operations. The memory 204 may also store the passenger information, the driver information, the vehicle information, and the real-time allocation information. The memory 204 may further store the QR or NFC information and the various requests initiated by the passenger 104 before, during, or after the ride. Examples of the memory 204 include, but are not limited to, a random-access memory (RAM), a read-only memory (ROM), a programmable ROM (PROM), and an erasable PROM (EPROM).

The data mining engine 206 may include suitable logic, circuitry, interfaces, and/or codes, executable by the circuitry, that may be configured to execute one or more data mining operations. For example, the data mining engine 206 may be configured to transmit the QR or NFC information as the query to the database server 108 and retrieve at least one of the driver, vehicle, and real-time allocation information from the database server 108. The data mining engine 206 may be configured to obtain the real-time ride information from the passenger device 102 or the driver device 110, and stores the real-time ride information in the memory 204. The data mining engine 206 may be implemented by one or more processors, such as, but are not limited to, an ASIC processor, a RISC processor, a CISC processor, and an FPGA.

The allocation engine 208 may include suitable logic, circuitry, interfaces, and/or codes, executable by the circuitry, that may be configured to execute one or more vehicle allocation operations. For example, based on the QR or NFC information received from the passenger device 102, the allocation engine 208 may be configured to process at least the real-time allocation information of the street-hailed vehicle 114 and determine the current availability status of the street-hailed vehicle 114. Thereafter, the allocation engine 208 may be configured to allocate the street-hailed vehicle 114 to the passenger 104 when the street-hailed vehicle 114 is available for the ride. The allocation engine 208 may be further configured to generate the allocation information based on the allocation of the street-hailed vehicle 114 to the passenger 104 and stores the allocation information in the memory 204. Thereafter, the allocation engine 208 may be further configured to transmit the allocation information to the passenger device 102 and/or the driver device 110. The allocation engine 208 may be implemented by one or more processors, such as, but are not limited to, an ASIC processor, a RISC processor, a CISC processor, and an FPGA.

The fare calculator engine 210 may include suitable logic, circuitry, interfaces, and/or codes, executable by the circuitry, that may be configured to execute one or more fare calculation operations. For example, the fare calculator engine 210 may be configured to calculate the ride fare for the ride based on at least an estimated time to reach the destination location, a ride distance of the ride, real-time traffic conditions, a vehicle type, real-time demand and supply, or any combination thereof. The fare calculator engine 210 may be further configured to store the ride fare in the memory 204. The fare calculator engine 210 may be implemented by one or more processors, such as, but are not limited to, an ASIC processor, a RISC processor, a CISC processor, and an FPGA.

The notification engine 212 may include suitable logic, circuitry, interfaces, and/or codes, executable by the circuitry, that may be configured to execute one or more interface rendering operations. For example, the notification engine 212 may be configured to render the user interfaces on the passenger device 102 for facilitating various in-vehicle services or features to the passenger 104 in the online manner. The user interface is a graphical user interface (GUI) that is rendered by the notification engine 212 on a display screen (not shown) of the passenger device 102 (or the driver device 110). The user interface may enable the passenger 104 (or the driver 112) to interact with the ride-hailing platform (such as the transportation server 106) by means of various information and options (e.g., graphical icons and visual indicators) included in the GUI.

In an exemplary embodiment, the notification engine 212 may be configured to render a booking user interface (shown in FIG. 3A) on the passenger device 102 that enables the passenger 104 to initiate an online booking for the ride using the street-hailed vehicle 114. The notification engine 212 may be configured to render a scanning user interface (shown in FIG. 3B) on the passenger device 102 that enables the passenger 104 to scan the QR code or the NFC sticker associated with the street-hailed vehicle 114. The notification engine 212 may be configured to render a destination user interface (shown in FIG. 3C) on the passenger device 102 that enables the passenger 104 to input the destination location for the ride. A digital map rendered on the passenger device 102 may be utilized, by the passenger 104, to specify the destination location for the ride. The notification engine 212 may be configured to render the digital map on the driver device 110 indicating various possible directions from the current location to the destination location. Upon start of the ride, the notification engine 212 may be configured to render an in-vehicle feature user interface (shown in FIG. 3D) on the passenger device 102 that enables the passenger 104 to initiate the requests for availing the in-vehicle features. For example, the notification engine 212 may be configured to render the tracking user interface (shown in FIG. 3E) on the passenger device 102 that enables the passenger 104 to track the ongoing ride. The notification engine 212 may be configured to render a payment user interface (shown in FIG. 3F) on the passenger device 102 that enables the passenger 104 to select the online payment mode to initiate the electronic transaction request to make the payment for the ride in the online manner. The notification engine 212 may be implemented by one or more processors, such as, but are not limited to, an ASIC processor, a RISC processor, a CISC processor, and an FPGA.

The streaming engine 214 may include suitable logic, circuitry, interfaces, and/or codes, executable by the circuitry, that may be configured to execute one or more streaming operations. For example, the streaming engine 214 may be configured to generate and communicate a streaming signal to the one or more preferred contacts of the passenger 104 based on the sharing request initiated by the passenger 104. The streaming signal may enable each preferred contact (e.g., a friend, a family member, or an acquaintance) to view the live feed of the in-vehicle activities associated with the passenger 104 riding in the street-hailed vehicle 114. The live feed may include audiovisual information (i.e., an audio signal, a video signal, or a combination thereof) of the in-vehicle activities captured by the image-capturing device 114a and the audio-capturing device 114b of the street-hailed vehicle 114. The streaming engine 214 may be implemented by one or more processors, such as, but are not limited to, an ASIC processor, a RISC processor, a CISC processor, and an FPGA.

The transceiver 216 may include suitable logic, circuitry, interfaces, and/or codes, executable by the circuitry, that may be configured to transmit (or receive) data to (or from) various servers or devices, such as the passenger device 102, the database server 108, or the driver device 110. Examples of the transceiver 216 may include, but are not limited to, an antenna, a radio frequency transceiver, a wireless transceiver, and a Bluetooth transceiver. The transceiver 216 may be configured to communicate with the passenger device 102, the database server 108, or the driver device 110 using various wired and wireless communication protocols, such as TCP/IP, UDP, LTE communication protocols, or any combination thereof. Various operations of the transportation server 106 along with their advantages and improvements will become apparent in conjunction with FIGS. 3A-3F.

FIG. 3A is a block diagram that illustrates a booking user interface 302a rendered on the passenger device 102, in accordance with an exemplary embodiment of the disclosure. The passenger device 102 is communicatively coupled with the transportation server 106. In a scenario where the passenger 104 may hail the street-hailed vehicle 114 for the ride in the offline manner and the passenger 104 may further want to avail the various in-vehicle services or features during the ride, the passenger device 102 may be utilized, by the passenger 104, to initiate the booking request for converting the offline ride into the online ride. In an embodiment, the notification engine 212 may be configured to render the booking user interface 302a on the passenger device 102 for facilitating the conversion of the offline ride into the online ride. The booking user interface 302a may present various selectable options corresponding to various types of ride or vehicle services offered by the vehicle service provider. For example, the various types of ride services may include daily rides or rental rides. Each ride may include various sub-categories such as ride-sharing, non-ride sharing, or the like. Further, various types of vehicles may include a mini vehicle, a micro vehicle, a prime vehicle, a 3-wheeler auto-rickshaw, or the like. The booking user interface 302a may further present the current location (i.e., a current pick-up location) of the passenger 104 that is same as the location of the street-hailed vehicle 114. The current pick-up location may be automatically captured by the service application running on the passenger device 102 using one or more position sensors (e.g., Global Positioning System (GPS) sensors) embedded in the passenger device 102. The booking user interface 302a may further present a scanning option 304 to the passenger 104. The scanning option 304 may be selected, by the passenger 104, to initiate the booking request for the ride using the street-hailed vehicle 114. For example, selection of the scanning option 304 enables the passenger 104 to perform the scanning process to scan the QR code or the NFC sticker associated with the street-hailed vehicle 114. An exemplary scanning process has been further described in detail in conjunction with FIG. 3B.

FIG. 3B is a block diagram that illustrates a scanning user interface 302b rendered on the passenger device 102, in accordance with an exemplary embodiment of the disclosure. In an embodiment, the notification engine 212 may be configured to render the scanning user interface 302b on the passenger device 102 when the scanning option 304 is selected by the passenger 104 to initiate the booking request for the ride using the street-hailed vehicle 114. Further, based on the scanning option 304 selected by the passenger 104, a camera module of the passenger device 102 may be automatically enabled or activated for the scanning process for scanning the QR code or the NFC sticker through a scanning area 306 of the scanning user interface 302b. To execute the scanning process, the passenger device 102 may be aligned, by the passenger 104, in a way to use the camera module to scan the QR code or the NFC sticker through the scanning area 306, as shown in FIG. 3B. Upon scanning the QR code or the NFC sticker, the passenger device 102 (or the service application running on the passenger device 102) may be configured to transmit the QR or NFC information to the transportation server 106 via the communication network 116.

In another embodiment, the scanning user interface 302b may further include a vehicle identifier tab 308. Using the vehicle identifier tab 308, the passenger 104 may specify the vehicle number of the street-hailed vehicle 114 to initiate the booking request for the ride, instead of using the scanning process. Based on the vehicle number specified by the passenger 104, the passenger device 102 (or the service application running on the passenger device 102) may be configured to transmit the vehicle number of the street-hailed vehicle 114 to the transportation server 106 via the communication network 116. In another embodiment, the passenger 104 may initiate the booking request for the ride by performing scanning of the QR code or the NFC sticker followed by specifying the vehicle number (or vice-versa). Based on scanning of the QR code or the NFC sticker and the vehicle number specified by the passenger 104, the passenger device 102 (or the service application running on the passenger device 102) may be configured to transmit the QR or NFC information, respectively along with the vehicle number of the street-hailed vehicle 114 to the transportation server 106 via the communication network 116.

In an embodiment, the processor 202 may be configured to receive the QR or NFC information (and/or the vehicle number) from the passenger device 102 and store the QR or NFC information (and/or the vehicle number) in the memory 204. The allocation engine 208 may be configured to retrieve the QR or NFC information (and/or the vehicle number) from the memory 204 and process the QR or NFC information (and/or the vehicle number) to determine whether the street-hailed vehicle 114 is available or unavailable for allocation to the passenger 104. The allocation engine 208 may be further configured to allocate the street-hailed vehicle 114 to the passenger 104 for the ride when the street-hailed vehicle 114 is available for allocation. The allocation engine 208 may be further configured to generate and communicate the allocation information to the passenger 104 and/or the driver 112. The allocation information may include at least one of the passenger, driver, or vehicle information and indicate allocation of the street-hailed vehicle 114 to the passenger 104 for the ride. Upon allocation, the driver 112 may transport the passenger 104 from the current location to the destination location. Thus, an offline way of riding between a plurality of locations using the street-hailed vehicle 114 may be converted into an online ride in which the passenger 104 may avail the various in-vehicle services or features that facilitate effective, efficient, and improved riding experiences to the passenger 104 as well as the driver 112.

FIG. 3C is a block diagram that illustrates a destination user interface 302c rendered on the passenger device 102, in accordance with an exemplary embodiment of the disclosure. In an embodiment, the notification engine 212 may be configured to render the destination user interface 302c on the passenger device 102. The destination user interface 302c may present an SOS button 310 on the passenger device 102. The SOS button 310 may be triggered by the passenger 104 to communicate an emergency alert to the one or more preferred contacts or emergency response teams in the event of the emergency incident. The destination user interface 302c may further present a destination tab 312. The destination tab 312 may be utilized, by the passenger 104, to specify the destination location of the ride. The destination user interface 302c may further present a digital map 314. The digital map 314 may be utilized, by the passenger 104, to specify the exact destination location of the ride. Based on the destination location specified and confirmed by the passenger 104, the passenger device 102 (or the service application running on the passenger device 102) may be configured to transmit the destination location to the transportation server 106. The notification engine 212 may be configured to receive the destination location from the passenger device 102 and store the received destination location in the memory 204. The allocation engine 208 may be configured to access the memory 204 to retrieve the destination location and update the allocation information. For example, the allocation engine 208 may communicate the destination location to the driver 112 of the street-hailed vehicle 114. The driver 112 may input the destination location on the digital map for navigating from the current location to the destination location of the passenger 104. In another example, the allocation engine 208 may locate the destination location on the digital map that may be further utilized by the driver 112 to navigate from the current location to the destination location of the passenger 104. Further, based on at least the destination location specified by the passenger 104, the fare calculator engine 210 may be configured to pre-calculate the ride fare for the ride and present the ride fare to the passenger 104. The fare calculator engine 210 may be further configured to dynamically update the ride-fare based on at least one of real-time traffic conditions, ride time, and the various in-vehicle services or features availed by the passenger 104 during the ride.

FIG. 3D is a block diagram that illustrates an in-vehicle feature user interface 302d rendered on the passenger device 102, in accordance with an exemplary embodiment of the disclosure. In an embodiment, the notification engine 212 may be configured to render the in-vehicle feature user interface 302d on the passenger device 102. The in-vehicle feature user interface 302d may present the SOS button 310 on the passenger device 102. The SOS button 310 may be triggered by the passenger 104 to initiate the emergency alert in the event of the emergency incident. The in-vehicle feature user interface 302d may further present one or more selectable options to the passenger 104 for availing the various in-vehicle services or features facilitated by the transportation server 106 in the online manner. The one or more selectable options may include an infotainment tab 316, an HVAC tab 318, a live feed tab 320, a ride tracking tab 322, and a ride sharing tab 324.

In an embodiment, the infotainment tab 316 may be selected, by the passenger 104, to control, modify, and execute (i.e., request, retrieve, play, view, stop, or the like) various infotainment-related services such as FM radio, live TV, movies, music, or the like. For example, when the infotainment tab 316 is selected by the passenger 104, a new pop-up window or user interface may be rendered on the passenger device 102. The new pop-up window may present the various infotainment-related services such as FM radio, live TV, movies, music, or the like. The passenger 104 may select any one of these services to view the multimedia content on the passenger device 102 or (any other computing device integrated with the street-hailed vehicle 114) during the ride. For example, the passenger 104 may select a movie option. In such a scenario, a control request may be generated and transmitted to the transportation server 106. The transportation server 106 may be configured to retrieve the requested multimedia content from the memory 204, the database server 108, or a third-party server (not shown) and present the retrieved multimedia content on the passenger device 102. The passenger 104 may provide one or more control commands to control the playback of the multimedia content on the passenger device 102.

In an embodiment, the HVAC tab 318 may be selected, by the passenger 104, to control, modify, and execute various HVAC-related operations such as increase or decrease in in-vehicle heating, ventilation, or air-conditioning or in-vehicle lighting. The various HVAC-related operations may be controlled, modified, and executed either directly (i.e., using direct communication between various in-vehicle HVAC devices and the passenger device 102 via the communication network 116) or indirectly (i.e., via the transportation server 106).

In an embodiment, the live feed tab 320 may be selected, by the passenger 104, to initiate sharing of the live feed of the in-vehicle activities with the one or more preferred contacts. For example, the passenger device 102 (or the service application running on the passenger device 102) may be configured to generate the sharing request when the live feed tab 320 is selected by the passenger 104. The passenger device 102 may further transmit the sharing request to the transportation server 106. The processor 202 may be configured to process the sharing request, retrieve the one or more preferred contacts of the passenger 104 from the database server 108, and store the one or more preferred contacts in the memory 204. The streaming engine 214 may be configured to retrieve the one or more preferred contacts from the memory 204 based on the sharing request and communicate the streaming signal to the one or more preferred contacts of the passenger 104. The streaming signal may enable each preferred contact to view the live feed of the in-vehicle activities associated with the passenger 104 riding in the street-hailed vehicle 114.

In an embodiment, the ride tracking tab 322 may be selected, by the passenger 104, to initiate the tracking request for tracking the ongoing ride. For example, based on the ride tracking tab 322 selected by the passenger 104, the processor 202 may be configured to retrieve the real-time ride information from the memory 204 or the database server 108 and communicate the real-time ride information to the passenger 104. The passenger 104 may view the real-time ride information including at least one of the position information, the route information, the direction information, the fare information, and the ride distance and time information associated with the ongoing ride. An exemplary tracking user interface has been shown and described in conjunction with FIG. 3E. In an embodiment, the ride sharing tab 324 may be selected, by the passenger 104, to view and share the real-time ride information with the one or more preferred contacts.

FIG. 3E is a block diagram that illustrates a tracking user interface 302e rendered on the passenger device 102, in accordance with an exemplary embodiment of the disclosure. In an embodiment, the notification engine 212 may be configured to render the tracking user interface 302e when the ride tracking tab 322 is selected by the passenger 104. The tracking user interface 302e may present the SOS button 310. The SOS button 310 may be triggered, by the passenger 104, in the event of the emergency incident. The tracking user interface 302e may further present the digital map (i.e., a ride-based navigation map) associated with the ongoing ride. The digital map may show a source location (A) 326 and a destination location (B) 328. The digital map may further show a route 330 that is currently being followed by the driver 112 to reach the destination location (B) 328. The digital map may further show a current location 332 of the street-hailed vehicle 114. The tracking user interface 302e may further present the ride sharing tab 324 that enables the passenger 104 to share the real-time ride information (for example, the digital map as shown in FIG. 3E) with the one or more preferred contacts.

FIG. 3F is a block diagram that illustrates a payment user interface 302f rendered on the passenger device 102, in accordance with an exemplary embodiment of the disclosure. In an embodiment, the notification engine 212 may be configured to render the payment user interface 302f on the passenger device 102 when the passenger 104 wants to make the online payment for the ride. The payment user interface 302f may present the SOS button 310. The SOS button 310 may be triggered, by the passenger 104, in the event of the emergency incident. The payment user interface 302f may further present one or more payment options 334 for making the online payment corresponding to the ride fare associated with the ride. The one or more payments options 334 may include at least a credit card option, a debit card option, an online wallet option, a net banking option, or the like. The payment user interface 302f may further present a make payment tab 336. The passenger 104 may select one of the one or more payment options 334 to select the online payment mode and then select the make payment tab 336. Based on the selection of the preferred online payment mode and the make payment tab 336 by the passenger 104, the passenger device 102 (or the service application running on the passenger device 102) generate and transmit the electronic transaction request to the transportation server 106 via the communication network 116. The transportation server 106 may be configured to receive and process the electronic transaction request to obtain the ride fare by facilitating debit of the electronic or digital money corresponding to the ride fare from the passenger's account of the passenger 104. In this way, the payment user interface 302f may facilitate the passenger 104 to make the payment corresponding to the ride fare in the online manner, which is convenient to the passenger 104 as well as the driver 112 of the street-hailed vehicle 114.

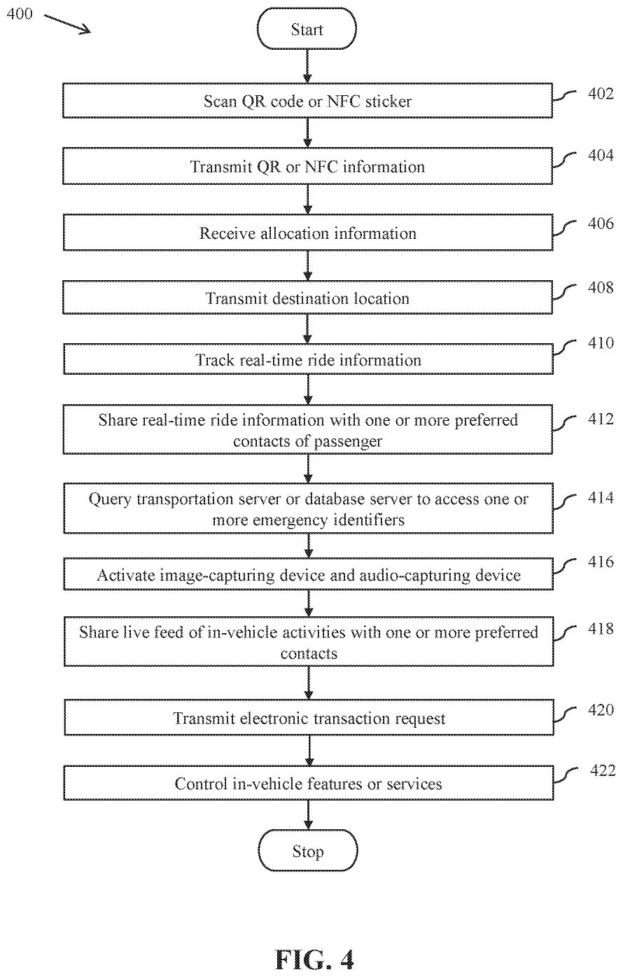

FIG. 4 is a flow chart 400 that illustrates a method for availing the offline to online booking of the street-hailed vehicle 114 by the passenger 104, in accordance with an exemplary embodiment of the disclosure.

At 402, the QR code or the NFC sticker is scanned. In this regard, the QR code or the NFC sticker associated with the street-hailed vehicle 114 may be scanned by the passenger 104 utilizing the service application running on the passenger device 102. Based on the scanning process initiated by the passenger 104, the passenger device 102 (or the service application running on the passenger device 102) may be configured to scan to the QR code or the NFC sticker to retrieve the QR or NFC information corresponding to the QR code or the NFC sticker, respectively.

At 404, the QR or NFC information is transmitted. The passenger device 102 (or the service application running on the passenger device 102) may be configured to transmit the QR or NFC information to the transportation server 106.

At 406, the allocation information is received. The passenger device 102 may be configured to receive the allocation information from the transportation server 106 when the street-hailed vehicle 114 is available for the ride requested by the passenger 104.

At 408, the destination location is transmitted. The passenger device 102 (or the service application running on the passenger device 102) may be configured to transmit the destination location (specified by the passenger 104) to the transportation server 106.

At 410, the real-time ride information is tracked. The passenger device 102 (or the service application running on the passenger device 102) may be configured to track the real-time ride information. The real-time ride information may include at least one of the position information, the route information, the direction information, the fare information, and the ride distance and time information associated with the ongoing ride.

At 412, the real-time ride information is shared with the one or more preferred contacts of the passenger 104. The passenger device 102 (or the service application running on the passenger device 102) may be configured to share the real-time ride information with the one or more preferred contacts, based on the sharing request initiated by the passenger 104.

At 414, the transportation server 106 or the database server 108 is queried to access the one or more emergency identifiers. The passenger device 102 (or the service application running on the passenger device 102) may be configured to query at least one of the transportation server 106 or the database server 108 to access the one or more emergency identifiers, based on the access request initiated by the passenger 104 in the event of the emergency incident.

At 416, the image-capturing device 114a and the audio-capturing device 114b are activated. The passenger device 102 (or the service application running on the passenger device 102) may be configured to activate at least one of the image-capturing device 114a and the audio-capturing device 114b to capture the in-vehicle activities of the street-hailed vehicle 114. The image-capturing device 114a and the audio-capturing device 114b may be activated based on the activation request initiated by the passenger 104.

At 418, the live feed of the in-vehicle activities is shared with the one or more preferred contacts. The passenger device 102 (or the service application running on the passenger device 102) may be configured to share the live feed of the in-vehicle activities with the one or more preferred contacts, based on the sharing request initiated by the passenger 104.

At 420, the electronic transaction request is transmitted. The passenger device 102 (or the service application running on the passenger device 102) may be configured to transmit the electronic transaction request to the transportation server 106. The electronic transaction request may be transmitted to make the online payment corresponding to the ride fare, based on the online payment mode selected by the passenger 104.

At 422, the in-vehicle features or services are controlled. The passenger device 102 (or the service application running on the passenger device 102) may be configured to control, modify, or execute the various in-vehicle features or services associated with the HVAC and the infotainment, based on the requests initiated by the passenger 104.

In another embodiment, the vehicle number of the street-hailed vehicle 114 may be utilized, by the passenger 104, to initiate the booking request for the ride. The passenger device 102 (or the service application running on the passenger device 102) may be configured to transmit the vehicle number to the transportation server 106. The transportation server 106 may be configured to validate the vehicle number and determine the availability status of the street-hailed vehicle 114 for the new allocation corresponding to the ride requested by the passenger 104. The transportation server 106 may be further configured to allocate the street-hailed vehicle 114 to the passenger 104 when the street-hailed vehicle 114 is available for the ride, and transmit the allocation information to the passenger device 102 and/or the driver device 110.

In another embodiment, the scanning process and the vehicle number of the street-hailed vehicle 114 may be utilized, by the passenger 104, to initiate the booking request for the ride. The passenger device 102 (or the service application running on the passenger device 102) may be configured to transmit the QR or NFC information along with the vehicle number to the transportation server 106. The transportation server 106 may be configured to process and validate the vehicle number and the QR or NFC information and determine the availability status of the street-hailed vehicle 114 for the new allocation corresponding to the ride requested by the passenger 104. The transportation server 106 may be further configured to allocate the street-hailed vehicle 114 to the passenger 104 when the street-hailed vehicle 114 is available for the ride, and transmit the allocation information to the passenger device 102 and/or the driver device 110.

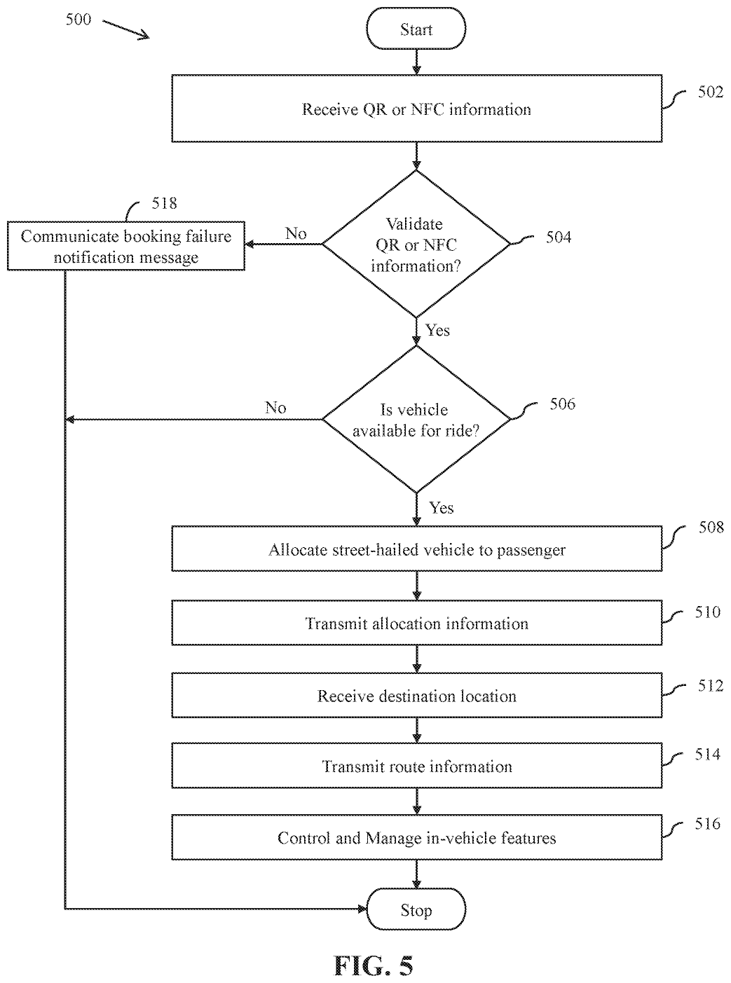

FIG. 5 is a flow chart 500 that illustrates a method for processing the offline to online booking of the street-hailed vehicle 114, in accordance with an exemplary embodiment of the disclosure. At 502, the QR or NFC information is received. The transportation server 106 may be configured to receive the QR or NFC information from the passenger device 102.

At 504, the QR or NFC information is validated. The transportation server 106 may be configured to perform a check to determine whether the QR or NFC information is valid or invalid. If at 504, the transportation server 106 determines that the QR or NFC information is invalid, then 518 is performed. However, if at 504, the transportation server 106 determines that the QR or NFC information is valid, then 506 is performed.

At 506, a check is performed to determine whether the street-hailed vehicle 114 is available or unavailable for the ride. If at 506, the transportation server 106 determines that the street-hailed vehicle 114 is unavailable for the ride, then the process ends here. However, if at 506, the transportation server 106 determines that the street-hailed vehicle 114 is available for the ride, then 508 is performed.

At 508, the street-hailed vehicle 114 is allocated to the passenger 104. The transportation server 106 may be configured to allocate the street-hailed vehicle 114 to the passenger 104.

At 510, the allocation information is transmitted. The transportation server 106 may be configured to transmit the allocation information to at least one of the passenger device 102 or the driver device 110.

At 512, the destination location is received. The transportation server 106 may be configured to receive the destination location from the passenger device 102.

At 514, the route information is transmitted. The transportation server 106 may be configured to transmit the route information to the driver device 110. The route information may be communicated in the form of the digital map by utilizing the destination location specified by the passenger 104.

At 516, the in-vehicle features are controlled and managed. The transportation server 106 may be configured to control and manage various operations corresponding to the in-vehicle features based on the requests initiated by the passenger 104.

At 518, a booking failure notification message is communicated. The transportation server 106 may be configured to communicate the booking failure notification message to the passenger 104. The booking failure notification message may include a message such as “invalid QR or NFC information” and end the process.

In another embodiment, the transportation server 106 may be configured to receive the vehicle number of the street-hailed vehicle 114 from the passenger device 102. The transportation server 106 may be further configured to validate the vehicle number. Upon successful validation of the vehicle number, the transportation server 106 may be further configured to determine the availability status of the street-hailed vehicle 114 for the new allocation corresponding to the ride requested by the passenger 104. The transportation server 106 may be further configured to allocate the street-hailed vehicle 114 to the passenger 104 when the street-hailed vehicle 114 is available for the ride, and transmit the allocation information to the passenger device 102 and/or the driver device 110.

In another embodiment, the transportation server 106 may be configured to receive the QR or NFC information along with the vehicle number from the passenger device 102. The transportation server 106 may be further configured to validate the QR or NFC information and the vehicle number. Upon successful validation, the transportation server 106 may be further configured to determine the availability status of the street-hailed vehicle 114 for the new allocation corresponding to the ride requested by the passenger 104. The transportation server 106 may be further configured to allocate the street-hailed vehicle 114 to the passenger 104 when the street-hailed vehicle 114 is available for the ride, and transmit the allocation information to the passenger device 102 and/or the driver device 110.

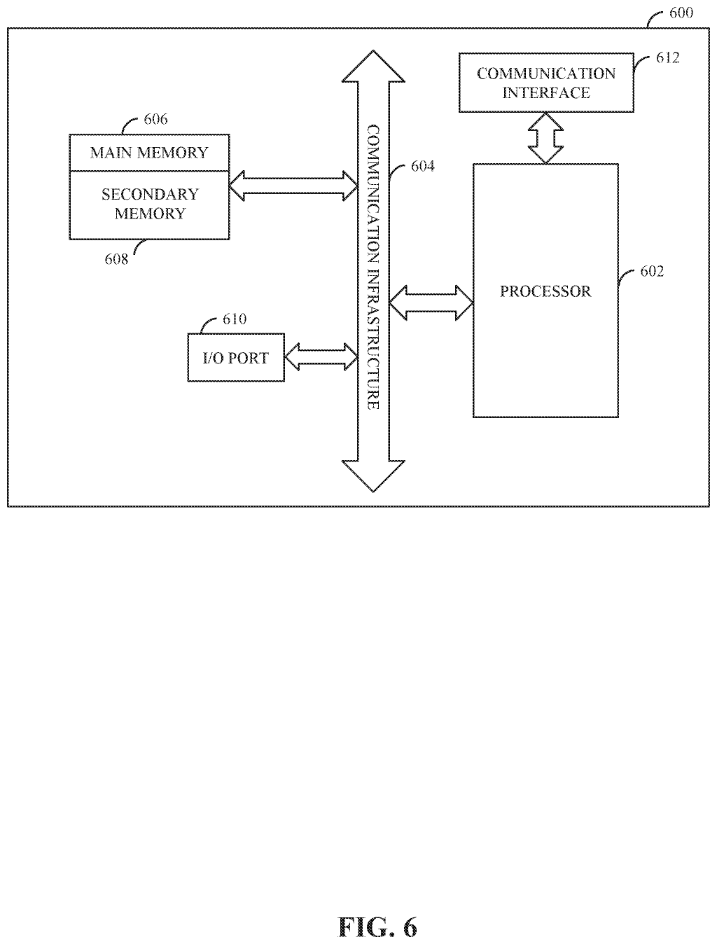

FIG. 6 is a block diagram that illustrates a system architecture of a computer system 600 for facilitating an offline to online booking of the street-hailed vehicle 114, in accordance with an exemplary embodiment of the disclosure. An embodiment of the disclosure, or portions thereof, may be implemented as computer readable code on the computer system 600. In one example, the transportation server 106 and the database server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the booking methods of FIGS. 4 and 5.

The computer system 600 may include a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, multi-core message-passing scheme, the communication network 116, or the like. The computer system 600 may further include a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 600 may further include an input/output (I/O) port 610 and a communication interface 612. The I/O port 610 may include various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communication port, and the like. Data transferred via the communication interface 612 may be signals, such as electronic, electromagnetic, optical, or other signals as will be apparent to a person skilled in the art. The signals may travel via a communications channel, such as the communication network 116, which may be configured to transmit the signals to the various devices that are communicatively coupled to the computer system 600. Examples of the communication channel may include a wired, wireless, and/or optical medium such as cable, fiber optics, a phone line, a cellular phone link, a radio frequency link, and the like. The main memory 606 and the secondary memory 608 may refer to non-transitory computer readable mediums that may provide data that enables the computer system 600 to implement the booking methods illustrated in FIGS. 4 and 5.

Various embodiments of the disclosure provide the passenger device 102 for performing the offline to online booking of the street-hailed vehicle 114 hailed by the passenger 104. The passenger device 102 may scan one of the QR code or the NFC sticker associated with the street-hailed vehicle 114 to retrieve the QR or NFC information, respectively. The QR or NFC information may include at least one of the driver or vehicle information associated with the street-hailed vehicle 114. The passenger device 102 may further transmit the retrieved QR or NFC information to the transportation server 106 for initiating the offline to online booking of the street-hailed vehicle 114. The passenger device 102 may further receive the allocation information that indicates at least the allocation of the street-hailed vehicle 114 to the passenger 104. The allocation information may be received based on the successful conversion of the offline to online booking of the street-hailed vehicle 114 by the transportation server 106, when the street-hailed vehicle 114 is available for the allocation. Based on the allocation information, the driver 112 of the street-hailed vehicle 114 may transport the passenger 104 from the current location to the destination location.

Various embodiments of the disclosure provide the transportation server 106 for processing the offline to online booking of the street-hailed vehicle 114 hailed by the passenger 104. The transportation server 106 may receive, from the passenger device 102, the QR or NFC information corresponding to the QR code or the NFC sticker associated with the street-hailed vehicle 114. The QR or NFC information may be received when the passenger device 102 scans the QR code or the NFC sticker to retrieve the QR or NFC information based on the offline to online booking of the street-hailed vehicle 114 initiated by the passenger 104. The QR or NFC information may include at least one of the driver or vehicle information associated with the street-hailed vehicle 114. The transportation server 106 may further process the received QR or NFC information to determine the availability of the street-hailed vehicle 114 for allocation to the passenger 104. The transportation server 106 may further allocate the street-hailed vehicle 114 to the passenger 104 based on the successful conversion of the offline to online booking of the street-hailed vehicle 114, when the street-hailed vehicle 114 is available for the allocation. The transportation server 106 may further transmit, to at least one of the passenger device 102 or the driver device 110, the allocation information that indicates at least the allocation of the street-hailed vehicle 114 to the passenger 104. Based on the allocation information, the driver 112 of the street-hailed vehicle 114 may transport the passenger 104 from the current location to the destination location.

Various embodiments of the disclosure provide a non-transitory computer readable medium having stored thereon, computer executable instructions, which when executed by a computer, cause the computer to execute operations for performing the offline to online booking of the street-hailed vehicle 114 hailed by the passenger 104. The operations include scanning, by the passenger device 102, one of the QR code or the NFC sticker associated with the street-hailed vehicle 114 for retrieving the QR or NFC information, respectively. The QR or NFC information may include at least one of the driver or vehicle information associated with the street-hailed vehicle 114. The operations further include transmitting, by the passenger device 102 to the transportation server 106, the retrieved QR or NFC information for initiating the offline to online booking of the street-hailed vehicle 114. The operations further include receiving, by the passenger device 102 from the transportation server 106, the allocation information indicating at least allocation of the street-hailed vehicle 114 to the passenger 104. The allocation information may be received based on the successful conversion of the offline to online booking of the street-hailed vehicle 114 by the transportation server 106, when the street-hailed vehicle 114 is available for the allocation. Based on the allocation information, the driver 112 of the street-hailed vehicle 114 may transport the passenger 104 from the current location to the destination location.

Various embodiments of the disclosure provide a non-transitory computer readable medium having stored thereon, computer executable instructions, which when executed by a computer, cause the computer to execute operations for processing the offline to online booking of the street-hailed vehicle 114 hailed by the passenger 104. The operations include receiving, by the transportation server 106 from the passenger device 102, the QR or NFC information corresponding to the QR code or the NFC sticker, respectively. The QR or NFC information may be received when the passenger device 102 scans the QR code or the NFC sticker to retrieve the QR or NFC information based on the offline to online booking of the street-hailed vehicle 114 initiated by the passenger 104. The QR or NFC information may include at least one of the driver or vehicle information associated with the street-hailed vehicle 114. The operations further include processing, by the transportation server 106, the received QR or NFC information to determine the availability of the street-hailed vehicle 114 for allocation to the passenger 104. The operations further include allocating, by the transportation server 106, the street-hailed vehicle 114 to the passenger 104 based on the successful conversion of the offline to online booking of the street-hailed vehicle 114, when the street-hailed vehicle 114 is available for the allocation. The operations further include transmitting, by the transportation server 106 to at least one of the passenger device 102 or the driver device 110, the allocation information indicating at least the allocation of the street-hailed vehicle 114 to the passenger 104. Based on the allocation information, the driver 112 of the street-hailed vehicle 114 may transport the passenger 104 from the current location to the destination location.

The disclosed embodiments encompass numerous advantages. The disclosure provides various booking methods and systems for facilitating the offline to online booking of the street-hailed vehicle 114 that has been hailed by the passenger 104 in the offline manner. In order to convert the offline way of hailing a vehicle (such as the street-hailed vehicle 114) for a ride into an online ride, the offline to online booking of the street-hailed vehicle 114 may be initiated by the passenger 104. The street-hailed vehicle 114 may be allocated to the passenger 104 for the requested ride based on the successful conversion of the offline to online booking of the street-hailed vehicle 114 by the transportation server 106. With such offline to online booking of the street-hailed vehicle 114, the passenger 104 or the driver 112 may not have to wait for the driver 112 or the passenger 104, respectively, at the passenger's pick-up location. Such offline to online booking of the street-hailed vehicle 114 further facilitates optimization of a dry run for the driver 112 that may result in higher earnings for the driver 112. Also, when the street-hailed vehicle 114 is converted into the online ride by the passenger 104, the passenger 104 may keep track of the ongoing ride in the online manner and may further share the live feed of the ongoing ride to preferred contacts, such as family, friends, or the like. Thus, the passenger 104 may enjoy enhanced safety and security services even when the passenger 104 is riding with the street-hailed vehicle 114. Furthermore, with such offline to online booking of the street-hailed vehicle 114, the passenger 104 may utilize the online payment mode for making the payment for the ride. Similarly, the driver 112 may accept the payment for the ride from the passenger 104 in the online manner that is hassle free. The passenger 104 may further enjoy online media content during the ride. Also, the passenger 104 can control the in-vehicle features associated with the HVAC in the online manner without disturbing the driver 112 who is driving the street-hailed vehicle 114.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the disclosure provide, among other features, systems and methods for offline to online booking of the street-hailed vehicle 114. While various exemplary embodiments of the disclosed booking systems and methods have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A booking method for a street-hailed vehicle, the booking method comprising:
scanning, by a passenger device, one of a quick response (QR) code or a near-field communication (NFC) sticker associated with the street-hailed vehicle for retrieving QR or NFC information, respectively, wherein the QR or NFC information includes at least one of driver or vehicle information associated with the street-hailed vehicle;
transmitting, by the passenger device to a transportation server via a communication network, the retrieved QR or NFC information for initiating an offline to online booking of the street-hailed vehicle; and
receiving, by the passenger device from the transportation server via the communication network, allocation information indicating at least allocation of the street-hailed vehicle to a passenger,
wherein the allocation information is received based on successful conversion of the offline to online booking of the street-hailed vehicle by the transportation server, when the street-hailed vehicle is available for the allocation, and
wherein a driver of the street-hailed vehicle transports the passenger from a current location to a destination location based on the allocation information.

2. The booking method of claim 1, further comprising transmitting, by the passenger device to the transportation server or a driver device of the driver via the communication network, the destination location specified by the passenger by way of a service application that runs on the passenger device.

3. The booking method of claim 1, further comprising tracking, by the passenger device via the communication network, real-time ride information by way of a service application that runs on the passenger device, wherein the real-time ride information includes at least one of position information, route information, direction information, fare information, and ride distance and time information associated with an ongoing ride.

4. The booking method of claim 3, further comprising sharing, by the passenger device via the communication network, the real-time ride information with one or more preferred contacts of the passenger by way of the service application, wherein the sharing is based on a sharing request initiated by the passenger.

5. The booking method of claim 1, further comprising querying, by the passenger device via the communication network, one of a database server or the transportation server to access one or more emergency identifiers, wherein the querying is based on an access request initiated by the passenger in an event of an emergency incident.

6. The booking method of claim 1, further comprising activating, by the passenger device via the communication network, at least one of an image-capturing device and an audio-capturing device associated with the street-hailed vehicle to capture in-vehicle activities of the street-hailed vehicle, wherein the activating is based on an activation request initiated by the passenger.

7. The booking method of claim 6, further comprising sharing, by the passenger device via the communication network, a live feed of the in-vehicle activities with one or more preferred contacts of the passenger, wherein the sharing is based on a sharing request initiated by the passenger.

8. The booking method of claim 1, further comprising transmitting, by the passenger device to the transportation server via the communication network, an electronic transaction request to make an online payment corresponding to a ride fare, wherein the transmitting is based on an online payment mode selected by the passenger.

9. The booking method of claim 1, further comprising controlling, by the passenger device, one or more in-vehicle features associated with heating, ventilation, and air conditioning (HVAC) and infotainment, based on one or more feature-related requests initiated by the passenger.

10. A booking method for a street-hailed vehicle, the booking method comprising:
receiving, by a transportation server from a passenger device via a communication network, quick response (QR) or near-field communication (NFC) information corresponding to a QR code or an NFC sticker, respectively, associated with the street-hailed vehicle,
wherein the QR or NFC information is received when the passenger device scans the QR code or the NFC sticker to retrieve the QR or NFC information based on an offline to online booking of the street-hailed vehicle initiated by a passenger, and
wherein the QR or NFC information includes at least one of driver or vehicle information associated with the street-hailed vehicle;
processing, by the transportation server, the received QR or NFC information to determine an availability of the street-hailed vehicle for allocation to the passenger;
allocating, by the transportation server, the street-hailed vehicle to the passenger based on successful conversion of the offline to online booking of the street-hailed vehicle when the street-hailed vehicle is available for the allocation; and
transmitting, by the transportation server to at least one of the passenger device or a driver device of a driver associated with the street-hailed vehicle via the communication network, allocation information indicating at least the allocation of the street-hailed vehicle to the passenger, wherein the driver transports the passenger from a current location to a destination location based on the allocation information.

11. The booking method of claim 10, further comprising receiving, by the transportation server from at least one of the passenger device or the driver device via the communication network, the destination location specified by the passenger, wherein the destination location is located on a digital map to facilitate navigation from the current location to the destination location.

12. The booking method of claim 10, further comprising rendering, by the transportation server on the passenger device via the communication network, a user interface for presenting real-time ride information that includes at least one of position information, route information, direction information, fare information, and ride distance and time information associated with an ongoing ride.

13. The booking method of claim 12, wherein the user interface includes a selectable option that enables the passenger to share the real-time ride information with one or more preferred contacts.

14. The booking method of claim 10, further comprising activating, by the transportation server, at least one of an image-capturing device and an audio-capturing device associated with the street-hailed vehicle to capture in-vehicle activities of the street-hailed vehicle, wherein the activating is based on an activation request initiated by the passenger.

15. The booking method of claim 14, further comprising sharing, by the transportation server, a live feed of the in-vehicle activities with one or more preferred contacts of the passenger, wherein the sharing is based on a sharing request initiated by the passenger.

16. The booking method of claim 10, further comprising receiving, by the transportation server from the passenger device via the communication network, an electronic transaction request initiated by the passenger to make an online payment corresponding to a ride fare, wherein the ride fare is obtained from the passenger based on processing of the electronic transaction request.

17. The booking method of claim 10, further comprising controlling, by the transportation server, one or more in-vehicle features associated with heating, ventilation, and air conditioning (HVAC) and infotainment, based on one or more feature-related requests initiated by the passenger.

18. A booking system for a street-hailed vehicle, the booking system comprising:
circuitry configured to:
receive, from a passenger device via a communication network, quick response (QR) or near-field communication (NFC) information corresponding to a QR code or an NFC sticker associated with the street-hailed vehicle,
wherein the QR or NFC information is received when the passenger device scans the QR code or the NFC sticker to retrieve the QR or NFC information based on an offline to online booking of the street-hailed vehicle initiated by a passenger, and
wherein the QR or NFC information includes at least one of driver or vehicle information associated with the street-hailed vehicle;
process the received QR or NFC information to determine an availability of the street-hailed vehicle for allocation to the passenger;
allocate the street-hailed vehicle to the passenger based on successful conversion of the offline to online booking of the street-hailed vehicle when the street-hailed vehicle is available for the allocation; and
transmit, to at least one of the passenger device or a driver device of a driver associated with the street-hailed vehicle via the communication network, allocation information indicating at least the allocation of the street-hailed vehicle to the passenger, wherein the driver transports the passenger from a current location to a destination location based on the allocation information.

19. The booking system of claim 18, wherein the circuitry is further configured to:
share real-time ride information with one or more preferred contacts of the passenger, based on a sharing request initiated by the passenger,
provide one or more emergency identifiers to the passenger, based on an access request initiated by the passenger in an event of an emergency incident,
activate at least one of an image-capturing device and an audio-capturing device associated with the street-hailed vehicle to capture in-vehicle activities of the street-hailed vehicle, based on an activation request initiated by the passenger, or
share a live feed of the in-vehicle activities with the one or more preferred contacts, based on a sharing request initiated by the passenger.

20. The offline to online booking system of claim 18, wherein the circuitry is further configured to:
receive an electronic transaction request from the passenger device, wherein the electronic transaction request is initiated by the passenger to make an online payment corresponding to a ride fare, and wherein the ride fare is obtained from the passenger based on processing of the electronic transaction request, or
control one or more in-vehicle features associated with heating, ventilation, and air conditioning (HVAC) and infotainment, based on one or more feature-related requests initiated by the passenger.
